(19) United States
(12) Patent Application Publication
(10) Pub. No.: US 2023/0058959 A1
(43) Pub. Date: Feb. 23, 2023

(54) SYSTEMS, METHODS, AND DEVICES FOR CAPACITY OPTIMIZATION IN A CLUSTER SYSTEM

(71) Applicant: Pepperdata, Inc., Santa Clara, CA (US)

(72) Inventor: Ki Moon Kim, Cupertino, CA (US)

(21) Appl. No.: 17/820,347

(22) Filed: Aug. 17, 2022

Related U.S. Application Data
(60) Provisional application No. 63/260,433, filed on Aug. 19, 2021.

(51) Int. Cl. G06F 9/50

(52) U.S. Cl. CPC G06F 9/5016; G06F 9/5072; G06F 9/505

(57) ABSTRACT

Some embodiments herein are directed to systems, methods, and devices, for capacity optimization on a Kubernetes container-orchestration system. Some embodiments herein may have the benefit of increasing utilization of cluster nodes so that more workloads may run with the same amount of resources.

### INCORPORATION BY REFERENCE TO ANY PRIORITY APPLICATIONS

This application claims priority benefit of U.S. Provisional Patent Application No. 63/260,433 filed Aug. 19, 2021, and titles, “SYSTEMS, METHODS, AND DEVICES FOR CAPACITY OPTIMIZATION IN A CLUSTER SYSTEM”, which is incorporated herein by reference in its entirety.

Any and all applications for which a foreign or domestic priority claim is identified in the Application Data Sheet as filed with the present application are hereby incorporated by reference under 37 CFR 1.57.

### BACKGROUND

### Field

The embodiments herein are generally related to management of resources in cluster computer systems. More particularly, some embodiments relate to systems, methods, and device for resource capacity optimization using extended resources.

Kubernetes is a portable, extensible, open-source platform for managing containerized workloads and services, that facilitates both declarative configuration and automation. Kubernetes has a large, rapidly growing ecosystem. Kubernetes services, support, and tools are widely available. A Kubernetes cluster consists of the components that represent the control plane and a set of machines called nodes. The Kubernetes API allows querying and manipulating the state of objects in Kubernetes. Users, the different components of the cluster, and external components all communicate with one another through the API server. Kubernetes objects are persistent entities in the Kubernetes system. Kubernetes uses these entities to represent the state of a cluster.

### SUMMARY

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

All of these embodiments are intended to be within the scope of the invention herein disclosed. These and other embodiments will become readily apparent to those skilled in the art from the following detailed description having reference to the attached figures, the invention not being limited to any particular disclosed embodiment(s).

Some embodiments herein relate to a method for capacity optimization in a cluster system, the method including: advertising, by a capacity optimizer via a Kubernetes application programming interface server, a node-level extended resource and a container-level extended resource; assigning, by the capacity optimizer, a first value to the node-level extended resource and a second value to the container-level extended resource, wherein the first value is a value of a node-level built-in resource, and wherein the second value is a value of a container-level built-in resource; periodically determining, via a metrics collector, a first usage amount of the node-level built-in resource and a second usage amount of the container-level built-in resource; and updating, by the capacity optimizer, the first value of the node-level extended resource based on the first usage amount to maintain the first usage amount between a first lower threshold and a first upper threshold, wherein the capacity optimizer is configured to increase the first value of the node-level extended resource if the first usage amount is below the first lower threshold, and decrease the first value of the node-level extended resource if the first usage amount is above the first upper threshold, or updating, by the capacity optimizer, the second value of the container-level built-in resource to maintain the second usage amount between a second lower threshold and a second upper threshold, wherein the capacity optimizer is configured to decrease the second value of the container-level extended resource if the second usage amount is below the second lower threshold, and increase the second value of the container-level extended resource if the second usage amount is above the second upper threshold.

In some embodiments, the node-level built-in resource can be a central processing unit resource and/or a memory resource.

In some embodiments, the container-level built-in resource can be a central processing unit resource and/or a memory resource.

In some embodiments, the method can include displaying, on a graphical user interface, the first value, the second value, the first value of the node-level built-in resource, the second value of the container-level built-in resource, the first usage amount, and the second usage amount.

In some embodiments, the first lower threshold can be 80 percent, and the first upper threshold can 100 percent.

In some embodiments, the cluster system can include Kubernetes.

Some embodiments herein relate to a method for capacity optimization in a Kubernetes cluster system, the method including: advertising, by a capacity optimizer, via a Kubernetes application programming interface, a CPU node-level extended resource, a memory node-level extended resource, a CPU container-level extended resource, and a memory container-level extended resource; assigning, by the capacity optimizer, a first value to the CPU node-level extended resource, wherein the first value is a value of a built-in node-level CPU; assigning, by the capacity optimizer, a second value to the memory node-level extended resource, wherein the second value is a value of a built-in node-level memory; assigning, by the capacity optimizer, a third value to the CPU container-level extended resource, wherein the third value is a value of a built-in container-level CPU; assigning, by the capacity optimizer, a fourth value to the memory container-level extended resource, wherein the fourth value is a value of a built-in container-level memory; updating, by the capacity optimizer, the value of the built-in container-level CPU and the value of the built-in container-level memory; periodically determining, via a metrics collector, a first usage amount of the built-in node-level CPU, a second usage amount of the built-in node-level memory, a third usage amount of the built-in container-level CPU, and a fourth usage amount of the built-in container-level memory; and automatically and dynamically updating, by the capacity optimizer, the first value, the second value, the third value, the fourth value, the value of the built-in container-level CPU, and/or the value of the built-in container-level memory to maintain the first usage amount, the second usage amount, the third usage amount, and the fourth usage amount between a lower threshold and an upper threshold.

In some embodiments, the method can include updating the value of the built-in container-level CPU includes lowering the value of the built-in container-level CPU, and wherein updating the value of the built-in container-level memory includes lowering the value of the built-in container-level memory.

In some embodiments, the capacity optimizer interacts with the Kubernetes cluster system via a Kubernetes application programming interface.

In some embodiments, the method can include displaying, on a graphical user interface, the first value, the second value, the third value, the fourth value, the value of the built-in node-level CPU, the value of the built-in node-level memory, the value of the built-in container-level CPU, and the value of the built-in container-level memory.

In some embodiments the metrics collector can periodically determine the first usage amount of the built-in node-level CPU, the second usage amount of the built-in node-level memory, the third usage amount of the built-in container-level CPU, and the fourth usage amount of the built-in container-level memory every 20 seconds.

In some embodiments, the method can include applying a text file, via a cluster administrator, to update the lower threshold and/or the upper threshold.

In some embodiments, the method can include applying a text file, via a cluster administrator, to update a frequency of the periodic determination of the first usage amount of the built-in node-level CPU, the second usage amount of the built-in node-level memory, the third usage amount of the built-in container-level CPU, and the fourth usage amount of the built-in container-level memory.

Some embodiments herein relate to a computing system for capacity optimization of a cluster system, the computing system including: one or more processors and an electronic storage medium configured with specific computer-executable instructions that, when executed, cause the one or more processors to at least: advertise a node-level extended resource and a container-level extended resource; assign a first value to the node-level extended resource and a second value to the container-level extended resource, wherein the first value is a value of a node-level built-in resource, and the second value is a value of a container-level built-in resource; periodically determine a first usage amount of the node-level built-in resource and a second usage amount of the container-level built-in resource; and automatically and dynamically update the first value, the second value, or the value of the container-level built-in resource based on the first usage amount and the second usage amount to maintain the first usage amount and the second usage amount between a lower threshold and an upper threshold, wherein if the first usage amount is below the lower threshold, the first value is increased or the value of the container-level built-in resource is decreased, and if the first usage amount is above the upper threshold, the first value is decreased or the container-level built-in resource is increased, and wherein if the second usage amount is below the lower threshold, the second value is increased, and if the second usage amount is above the upper threshold, the second value is decreased.

In some embodiments, the computing system can include a graphical user interface for displaying the first value, the second value, the value of the node-level built-in resource, the value of the container-level built-in resource, the first usage amount, and the second usage amount.

In some embodiments, the node-level built-in resource can be CPU and/or memory.

In some embodiments, the container-level built-in resource can be CPU and/or memory.

In some embodiments, periodically determining the first usage amount and the second usage amount can occur every 20 seconds.

In some embodiments, the lower threshold can be 80 percent, and the upper threshold can be 100 percent.

In some embodiments, the cluster system can include Kubernetes.

### BRIEF DESCRIPTION OF THE DRAWINGS

These and other features, aspects, and advantages of the present application are described with reference to drawings of certain embodiments, which are intended to illustrate, but not limit the present disclosure. It is to be understood that the attached drawings are for the purpose of illustrating concepts disclosed in the present application and may not be to scale.

FIG. 1 illustrates an example implementation architecture of a capacity optimizer on Kubernetes according to some embodiments herein.

FIG. 2 illustrates a flowchart of an example method of configuring one or more extended resources according to some embodiments herein.

FIG. 3 illustrates a flowchart of an example method of capacity optimization according to some embodiments herein.

FIG. 4 is a block diagram illustrating a computer hardware system configured to run software for implementing one or more embodiments of a capacity optimizer according to some embodiments herein.

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present technology.

Some embodiments herein are directed to systems, methods, and devices for capacity optimization within a container-orchestration system, such as, for example, Kubernetes. The systems, methods, and devices herein may increase utilization of cluster nodes such that more workloads may run on each node configured with the same amount of resources.

Without a capacity optimizer, a container orchestration system may function by launching containers based on a configured resource capacity of nodes using a scheduler. If a node has enough resources, the scheduler allocates the node to a workload container and launches the assigned workload. The scheduler assumes all the allocated resources are fully used by the workload containers. If nodes run out of configured resources, future workload containers will remain pending.

Typically, developers submit applications to Kubernetes and request an allocation of built-in resources with a worst-case scenario in mind. For example, a developer may request 10 gigabytes of memory and 2-cores of central processing unit (CPU) for each container. The developer may base the request on prior experience of containers using a maximum of, for example, 9 gigabytes of memory and 1.5-cores of CPU when the containers handled an unusually large amount of input data. The application will be killed if the containers are not allocated enough memory to run or the application will slow down if containers are not allocated enough CPU to run, so the developer may request 10 gigabytes of memory and 2-cores of CPU to ensure the application runs properly in the worse-case scenario. However, on average, the containers may use significantly less resources, for example, 5 gigabytes of memory and 1-core of CPU when the containers handle a usual amount of data. Thus, in a normal configuration, in a typical allocation of built-in resources (e.g., worst-case scenario configuration), a large amount of resources may be unused, and the configuration cannot be changed in real-time to more efficiently allocate these unused resources.

In a typical configuration, Kubernetes determines the number of containers in a node based on the requested allocation of built-in resources. As discussed above, a static amount of resources is reserved on each node, and the static amount of resources are allocated based on the requested resource amount. For example, if the developer requests 10 gigabytes for each container, and the node has 100 gigabytes of memory, the node may run a maximum of 10 containers. If each container uses about 5 gigabytes of memory on average in actual usage, only 50 gigabytes of the available 100 gigabytes will be used, leaving 50 gigabytes of used resources.

Unlike other container orchestration systems, Kubernetes does not have an application programming interface (API) for adjusting the configured capacity of nodes in real-time. Thus, Kubernetes does not allow updating node configuration of built-in resources such as CPU and memory resources. Without the capacity optimizer described herein, a container orchestration system may not be able to utilize all of the available resources on a node. A Kubernetes scheduler may only launch containers based on a configured resource capacity of nodes. If a node has enough configured resources, the scheduler allocates the node to a workload container and launches the assigned workload. The scheduler assumes all the allocated resources are fully used by the workload containers. If nodes run out of configured resources, future workload containers will remain pending.

In some embodiments herein, a container orchestration system, utilizing a capacity optimizer, may function by monitoring the actual resource usage of containers on the nodes and reconfiguring resource allocation in real-time using Kubernetes extended resources. For example, if there are resources allocated but not used, the capacity optimizer may increase the configured capacity of the nodes. Upon increasing the configured capacity of the nodes, the scheduler may be allowed to launch additional containers on those nodes, effectively increasing the capacity of the cluster.

Kubernetes supports extended resources as an extension. Extended resources are fully qualified resource names outside the kubernetes.io domain. Extended resources allow cluster operators to advertise, and users to consume, custom third-party resource types that are not represented by built-in Kubernetes resource types. For example, a cluster may have Nvidia GPUs that Kubernetes does not recognize. Extended resources allow cluster operators to advertise such custom resources on cluster nodes, which may allow cluster users to consume the resources in pods. In some embodiments, the capacity optimizer may utilize the extended resources functionality of Kubernetes to manipulate the allocated resources to nodes in the cluster to optimize capacity of resources. In some embodiments, to utilize extended resources, a cluster operator must advertise one or more extended resources, and the one or more extended resources must be requested in pods. In some embodiments, the capacity optimizer may utilize both node-level extended resources, which are associated with cluster nodes, and container-level extended resources, which are associated with workload containers.

In some embodiments herein, to reduce the amount of unused resources in a Kubernetes cluster, a capacity optimizer may advertise and request extended resources to represent, as proxies, one or more built-in Kubernetes resource types (e.g., CPU and memory). In some embodiments, the capacity optimizer may update values of the extended resources to artificially manipulate a Kubernetes container-orchestration system in real-time, such that the orchestration system has data that informs the orchestration system that a workload container has more resources available and allow containers to be allocated to the nodes, despite there being no actual increase in node resources available. In particular, in some embodiments, the capacity optimizer may dynamically increase the value of a node-level resource amount (e.g., memory and/or CPU) to cause the Kubernetes scheduler to allocate additional containers to nodes.

### Implementation of a Capacity Optimizer on Kubernetes

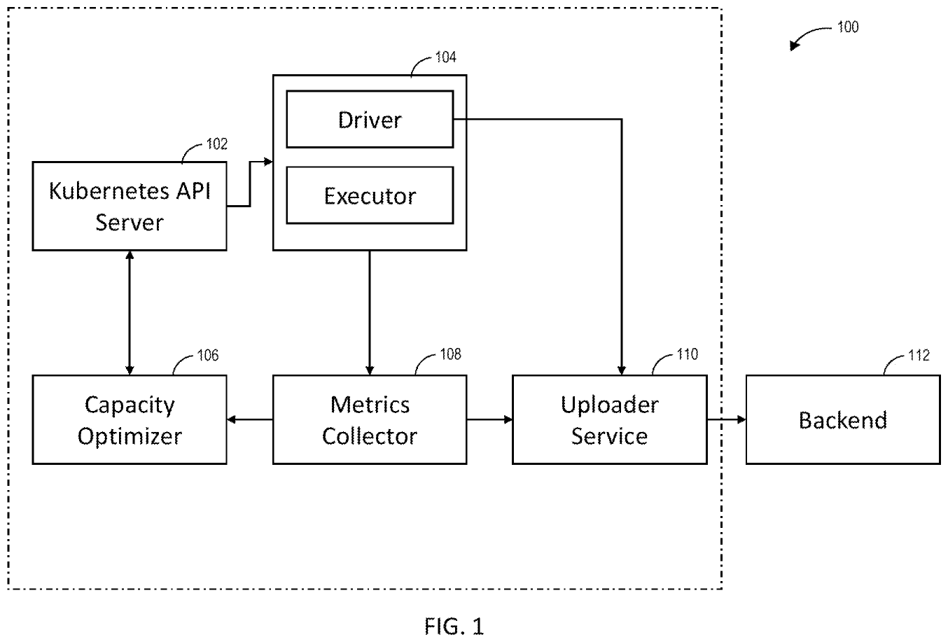

FIG. 1 illustrates an example implementation architecture 100 of a capacity optimizer 106 on Kubernetes according to some embodiments herein. In some embodiments, the implementation architecture 100 may include a metrics collector 108, which may collect some or all Kubernetes metrics and transmit them to the capacity optimizer 106 and an uploader service 110. For example, in some embodiments, the metrics collector may monitor the cluster and nodes to determine the actual amount of resources, such as CPU and/or memory, being used by each container in the cluster. In some embodiments, the capacity optimizer 106 may run as a service on Kubernetes and update managed resources based on dynamically updated cluster metrics. In some embodiments, the capacity optimizer 106 may send the decided capacity amount of managed resources to a Kubernetes API server 102 to update the advertised extended resources in Kubernetes. In some embodiments, on containers, the capacity optimizer 106 may intercept a communication when containers are submitted to the cluster using the Kubernetes webhook extension. The Kubernetes API server 102 may manage or interact with the driver and executor 104 of an application.

In some embodiments, the implementation architecture 100 may comprise an uploader service 110, which may upload metrics collected from the metrics collector 108 as well as workloads to a backend system 112, such as a cloud system. The metrics collector 108 may periodically retrieve metrics or usage information. The usage information may include an amount of memory being used, an amount of CPU being used, and/or an amount of any other resource being used. The metrics collector 108 may retrieve the usage information in real time or periodically at predetermined times or a predetermined frequency. For example, the metrics collector 108 may retrieve the usage information at a time interval of about 1 second, about 5 seconds, about 10 seconds, about 20 seconds, about 30 seconds, about 1 minute, about 5 minutes, about 10 minutes, about 20 minutes, about 30 minutes, about 1 hour, about 2 hours, about 3 hours, about 4 hours, about 5 hours, about 6 hours, and/or any value between the aforementioned values.

In some embodiments, the backend system 112 may store the metrics or usage information, present cluster status to users, and produce long term usage insights based on analysis of the metrics via a dynamic user interface (UI). In some embodiments, the backend system 112 may include a display. The display may present the cluster status to users on a graphical user interface (GUI). In some embodiments, the backend system 112 may include a web application, a desktop application, or any other graphical user interface (GUI). In some embodiments, the cluster status may include a usage amount of a built-in resource, a lower threshold, an upper threshold, a value of one or more extended resources, a value of one or more built-in resources, and/or any other value associated with the cluster status. The usage amount may be a percentage of the built-in resource in use, or the usage amount may be an amount of the built-in resource in use. For example, if the built-in resource is 10 gigabytes of memory and 8 gigabytes are in use, the usage amount may be 8 gigabytes or 80 percent. The backend system 112 may display the cluster status as a time series and/or a current cluster status. In some embodiments, the backend system 112 may display information about how the capacity optimizer 106 is optimizing the node and/or container.

In some embodiments, a user may update the usage threshold, the maximum usage, the predetermined time, or frequency, and/or any other settings or information of the capacity optimizer 106. In some embodiments, the user may update the information related to the capacity optimizer 106 by applying a file to the capacity optimizer 106. The file may be a text file, a Microsoft Word file, and OpenOffice Writer document file, a PDF files, a Rich Text Format file, a LaTex file, WordPerfect file, or any other text file format. The user may include a cluster administrator, a cluster operator, and/or any other user.

### Capacity Optimization

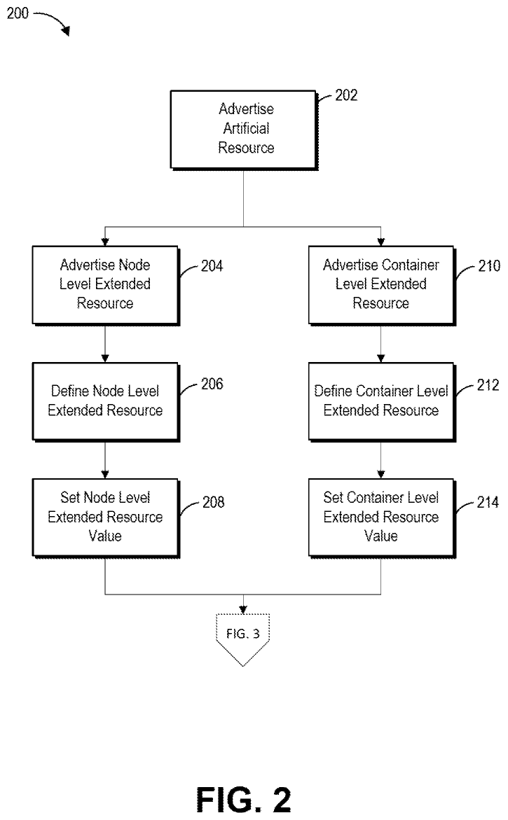

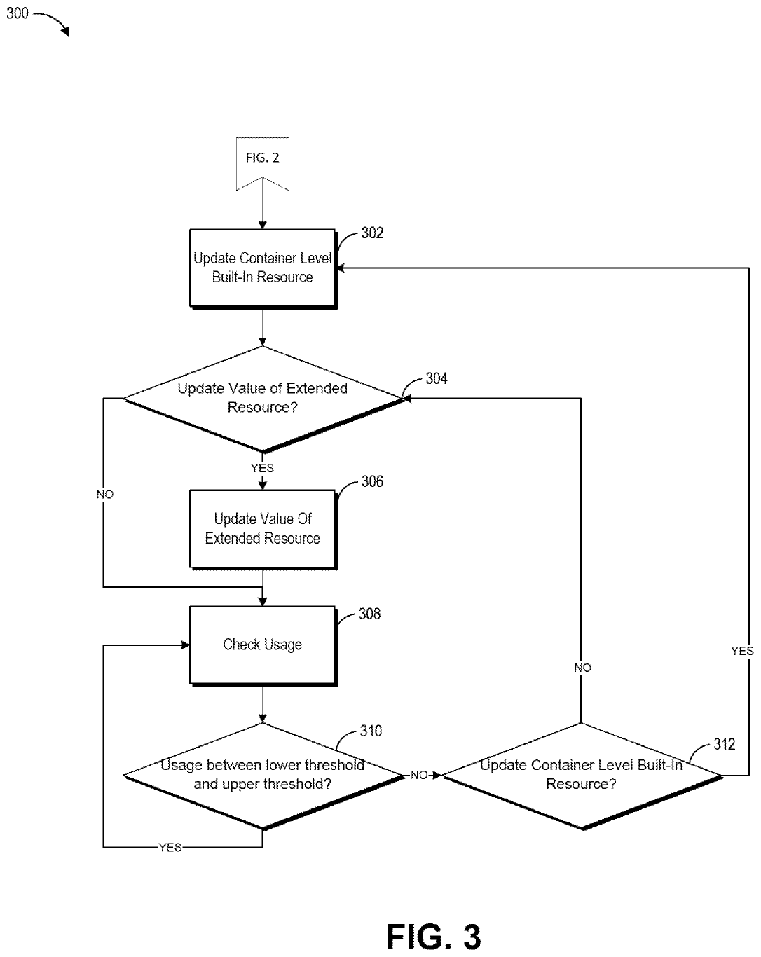

FIGS. 2-3 illustrate a method of capacity optimization according to some embodiments herein. FIG. 2 illustrates a method 200 of setting up one or more extended resources for capacity optimization according to some embodiments. In some embodiments, at step 202, the capacity optimizer 106 may advertise one or more artificial extended resources through the Kubernetes API server 102. In some embodiments, the one or more artificial resources may include a name or identifier. In some embodiments, the name or identifier may be pepperdata.com/cpu, pepperdata.com/memory, or any other name or identifier.

In some embodiments, at step 204, the capacity optimizer 106 may advertise a node-level extended resource. In some embodiments, the capacity optimizer 106 may advertise the node-level extended resource via the Kubernetes API server 102.

In some embodiments, at step 206, the capacity optimizer 106 may use the one or more artificial resources to define the node-level extended resource. The capacity optimizer 106 may define the node-level extended resource by associating the node-level extended resource with a node-level built-in resource, such as the CPU and/or memory of the node. The node-level built-in resource may include CPU, memory, and/or any other built-in resource. In some embodiments, the capacity optimizer 106 may use an artificial resource with a name based on the association between the built-in resource and the node-level extended resource. For example, if the node-level extended resource is associated with a built-in CPU, the capacity optimizer may use an artificial resource with the name pepperdata.com/cpu.

In some embodiments, at step 208, the capacity optimizer 106 may set a value of the node-level extended resource. The capacity optimizer 106 may access a value of the node-level built-in resource via the Kubernetes API server 102. The capacity optimizer 106 may set the value of the node-level extended resource as the value of the node-level built-in resource. For example, if the node includes 20 cores of CPU, the capacity optimizer 106 may set the value of the node-level extended resource as 20.

In some embodiments, the capacity optimizer 106 may repeat steps 204-208 for each node-level built-in resource. In some embodiments, the capacity optimizer 106 may perform each step 204-208 for each node-level built-in resource before performing a next step for each other node-level built-in resource. In other embodiments, the capacity optimizer 106 may perform steps 204-208 for a first node-level built-in resource before performing steps 204-208 for another node-level built-in resource.

In some embodiments, at step 210, the capacity optimizer 106 may advertise a container-level extended resource. In some embodiments, the capacity optimizer 106 may advertise the container-level extended resource via the Kubernetes API server 102.

In some embodiments, at step 212, the capacity optimizer 106 may use the one or more artificial extended resources to define the container-level extended resource. The capacity optimizer 106 may define the container-level extended resource by associating the container-level extended resource with a container-level-built in resource. The container-level built-in resource may include CPU, memory, and/or any other built-in resource. In some embodiments, the capacity optimizer 106 may use an extended resource with a name based on the association between the built-in resource and the container-level extended resource. For example, if the container-level extended resource is associated with a built-in CPU, the capacity optimizer 106 may use an extended resource with the name pepperdata.com/cpu.

In some embodiments, at step 214, the capacity optimizer 106 may set a value of the container-level extended resource. The capacity optimizer 106 may access a value of the container-level built-in resource via the Kubernetes API server 102. The capacity optimizer 106 may set the value of the container-level extended resource as the value of the container-level built-in resource. For example, if the container includes 2 cores of CPU, the capacity optimizer 106 may set the value of the container-level extended resource as 2.

In some embodiments, the capacity optimizer 106 may repeat steps 210-214 for each container-level built-in resource. In some embodiments, the capacity optimizer 106 may perform each step 210-214 for each container-level built-in resource before performing a next step for each other container-level built-in resource. In other embodiments, the capacity optimizer 106 may perform steps 210-214 for a first container-level built-in resource before performing steps 210-214 for another container-level built-in resource.

In some embodiments, the capacity optimizer 106 may perform steps 204-208 for each node-level built-in resource before the capacity optimizer 106 may perform steps 210-214 for each container-level resource. In some embodiments, the capacity optimizer 106 may perform steps 210-214 for each container-level built-in resource before the capacity optimizer 106 may perform steps 204-208 for each node-level built-in resource.

In other embodiments, the capacity optimizer 106 may perform steps 204 and 210 for each node-level and container-level built-in resource before the capacity optimizer 106 may perform steps 206 and 212 for each other node-level and container-level built-in resource. The capacity optimizer 106 may perform steps 206 and 212 for each node-level and container-level built-in resource before the capacity optimizer 106 may perform steps 208 and 214 for each other node-level and container-level built-in resource.

FIG. 3 illustrates a flowchart of an example method of capacity optimization 300 according to some embodiments. In some embodiments, when a container requests allocation of extended resources as well as built-in resources, the Kubernetes scheduler monitors if nodes have enough configured amounts for both extended resources as well as built-in resources. In some embodiments, extended resources may be dynamically adjusted to reflect a true amount of available capacity. Kubernetes does not allow software to update the built-in resources at a node-level, but software may update built-in resources at a container-level when a container is submitted. By updating node-level extended resources, container-level extended resources, and/or container-level built-in resources, the capacity optimizer 106 may artificially instruct Kubernetes that a node and/or container includes more resources than the node and/or container physically includes.

In some embodiments, the metrics collector 108 and capacity optimizer 106 may determine that a node/container has unused resources. In some embodiments, at step 302, the capacity optimizer 106 may update the value of the container-level built-in resource (e.g., the amount of CPU and/or memory allocated for each container) to update an upper limit of a number of containers that may be allocated to each node. In some embodiments, the capacity optimizer 106 may decrease the value of the container-level built-in resource to increase the upper limit of the number of containers on each node. For example, the capacity optimizer 106 may decrease the value of the container-level built in resources to one third of the value to increase the upper limit of the number of containers on each node by 300 percent. Therefore, if the node included an upper limit of 10 containers before the capacity optimizer 106 decreased the value of the container-level built in resources, the node may now include an upper limit of 30 containers. In some embodiments, the capacity optimizer 106 may increase the value of the container-level built-in resources to decrease the upper limit of the number of containers on each node.

In some embodiments, at step 304, the capacity optimizer 106 may determine if the value of one or more of the extended resources should be updated. The extended resources may include one or more node-level extended resources and/or one or more container-level extended resources. The capacity optimizer 106 may base the determination on previously obtained usage information from the metrics collector 108 as further discussed below with reference to step 310.

If, at step 304, the capacity optimizer 106 determines that the value of one or more of the extended resources should be updated, at step 306, the capacity optimizer 106 may update the value of one or more of the extended resources. If, at step 304, the capacity optimizer 106 determines that the value of one or more of the extended resources should not be updated, the capacity optimizer 106 may skip step 306.

In some embodiments, at step 308, the capacity optimizer 106 may monitor the usage amount of one or more of the built-in resources. The capacity optimizer 106 may monitor the usage amount of one or more of the built-in resources associated with the extended resources the capacity optimizer 106 updates the value of at step 304, or the capacity optimizer 106 may monitor the usage amount of every built-in resource. In some embodiments, the capacity optimizer 106 may retrieve the usage amount from the metrics collector 108. In some embodiments, the metrics collector 108 may automatically transmit the usage amount or any other metrics to the capacity optimizer 106 when the metrics collector 108 retrieves the usage amount or any other metrics. In some embodiments, the capacity optimizer 106 may transmit a retrieval request to the metrics collector 108 and in response to the retrieval request, the metrics collector 108 may retrieve the usage amount or any other metrics. The capacity optimizer 106 may transmit the retrieval request periodically at a predetermined time or frequency. For example, the capacity optimizer 106 may transmit the retrieval request a time interval of about 1 second, about 5 seconds, about 10 seconds, about 20 seconds, about 30 seconds, about 1 minute, about 5 minutes, about 10 minutes, about 20 minutes about 30 minutes, about 1 hour, about 2 hours, about 3 hours, about 4 hours, about 5 hours, about 6 hours, and/or any value between the aforementioned values.

In some embodiments, at step 310, the capacity optimizer 106 may determine if the usage amount is between a lower threshold and an upper threshold. In some embodiments, the lower threshold and/or the upper threshold may be set by the user, or the lower threshold and/or upper threshold may be a predetermined amount. In some embodiments, each built-in resource may have a different lower threshold and/or upper threshold. In some embodiments, the lower threshold may be about 80% and the upper threshold may be about 100%. In some embodiments, the lower threshold may be about 0%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, and/or between any of the aforementioned values.

In some embodiments, the upper threshold may be between about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, about 100%, and/or between any of the aforementioned values.

In some embodiments, at step 310, the capacity optimizer 106 may determine if the usage amount is moving towards the lower threshold or the upper threshold over time. If the capacity optimizer 106 determines that the usage amount is moving towards the lower threshold or the upper threshold over time and/or that the usage amount is an amount close to the lower threshold or the upper threshold, the capacity optimizer 106 may determine the usage amount is not between the lower threshold and the upper threshold.

In some embodiments, if the usage amount is between the lower threshold and the upper threshold, the capacity optimizer 106 may repeat step 308 and may monitor the usage amount of one or more of the built-in resources. In some embodiments, the capacity optimizer 106 may repeat step 308 at the predetermined time. In some embodiments, the capacity optimizer 106 may repeat steps 308 and 310 until the capacity optimizer 106 determines at step 310 that the usage amount is not between the lower threshold and the upper threshold.

In some embodiments, if at 310, the capacity optimizer 106 determines that the usage amount is not between the lower threshold and the upper threshold, the capacity optimizer 106 may determine if the container-level built in resource 312 should be updated. If the capacity optimizer 106 determines that the container-level built-in resource should be updated, the implementation architecture 100 may repeat the method for capacity optimization 300 at step 302. If the capacity optimizer 106 determines that the container-level built-in resource should not be updated, the implementation architecture 100 may repeat the method for capacity optimization 300 at step 304.

In some embodiments, the implementation architecture 100 may repeat at least a portion of the method for capacity optimization 300 to gradually and/or iteratively update one or more of the extended resources and/or one or more of the container-level built-in resources until the usage amount for each built-in resource is between the lower threshold and the upper threshold, in this way the implementation architecture 100 may be a feedback loop. For example, if the node has 100 gigabytes of memory and 10 containers, with an allocated memory of 10 gigabytes, and the containers have used 5 gigabytes of memory each for about 20 minutes, the capacity optimizer 106 may update a node-level memory extended resource to 120 gigabytes to launch two more containers on the node. After the predetermined time, the metrics collector may retrieve a usage amount. If the usage amount is below the lower threshold, the capacity optimizer 106 may increase the node-level memory extended resource to 140 gigabytes and the node can accept two more containers. After the predetermined time, the metrics collector may again retrieve the usage amount. If the usage amount is below the lower threshold the capacity optimizer may increase the node-level memory extended resource again. The capacity optimizer 106 may continue to iteratively increase the node-level memory extended resource until the usage amount is above the lower threshold.

In some embodiments, at step 302, the capacity optimizer 106 may lower the value of the container-level built-in resource to increase the upper limit of a number of containers that may be allocated to each node. In this way, the node can accept more containers since the containers will now require less resources than the requested amount. After the capacity optimizer 106 lowers the value of the container-level built-in resource, at step 302, the capacity optimizer 106 may determine that the value of the extended resources should be updated at step 304, and the capacity optimizer 106 may increase the value of the extended resources at step 306. After the capacity optimizer 106 updates the value of the extended resources at step 306, the capacity optimizer 106 or metrics collector 108 may retrieve the usage amount after the predetermined time, at step 308. If capacity optimizer 106, at step 310, determines the usage amount is between the lower threshold and the upper threshold, the implementation architecture 100 can repeat steps 308 and 310 until the capacity optimizer 106 determines the usage amount is not between the lower threshold and the upper threshold. If the capacity optimizer 106, at step 310, determines the usage amount is below the lower threshold, the implementation architecture 100 can repeat steps 304-310 to iteratively or gradually increase the value of the node-level extended resources and/or decrease the value of the container-level extended resources until the capacity optimizer 106 determines the usage amount is between the lower threshold and the upper threshold.

In some embodiments, the implementation architecture 100 may repeat at least a portion of the method for capacity optimization 300 to maintain the usage amount between the lower threshold and the upper threshold. In some embodiments, when the usage amount has increased substantially, the implementation architecture 100 may maintain an amount of node-level extended resources such that a node would saturate the built-in node level resources but not increase the usage amount above the upper threshold overload the node. In some embodiments, if a node is overloaded, the implementation architecture may iteratively and gradually lower the amount of node-level extended resources such that the usage amount is below the upper threshold, so the node is less overloaded or not overloaded.

In some embodiments, the capacity optimizer 106 may use machine learning (ML) and/or artificial intelligence (AI) to make determinations automatically and dynamically at one or more steps of the method 200 and/or one or more steps of the method for capacity optimization 300.

In some embodiments, the implementation architecture 100 may perform one or more steps of the method for capacity optimization 300 to optimize one or more built-in resources at a same time.

In some embodiments, the built-in resources may include special hardware resource types beyond the built-in resource types such as CPU and memory. Examples of special hardware resource types include, but are not limited to, disk I/O capacity, network bandwidth, and graphics processing units (GPUs), among others. Special workloads such as High-Performance Computing (HPC) or Artificial Intelligence/Machine Learning (AI/ML) may heavily utilize the special hardware resource types. In some embodiments, the special workloads would suffer from unpredictable performance when too many workloads compete for the special hardware resource types without any scheduler coordination, as the scheduler does not support the special hardware resource types. In some embodiments, Kubernetes extended resources may represent the special hardware resource types in a static allocation manner, such that workloads are gated by static scheduling nature.

In some embodiments, the capacity optimizer 106 may add extended resource types for the special hardware resource types. In some embodiments, the capacity optimizer 106 may manage the special hardware resource types dynamically, as discussed above with respect to extended resources, such that more workloads may run with a same amount of underlying resources.

### Computer System

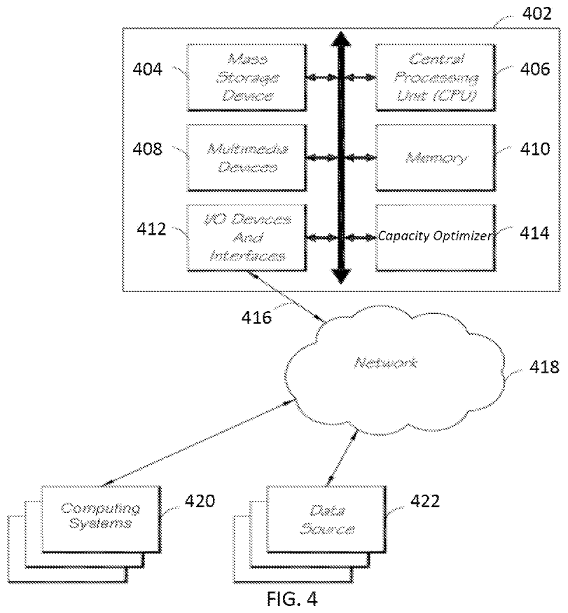

In some embodiments, the systems, processes, and methods described herein are implemented using a computing system, such as the one illustrated in FIG. 4. The example computer system 402 is in communication with one or more computing systems 420 and/or one or more data sources 422 via one or more networks 418. While FIG. 4 illustrates an embodiment of a computing system 402, it is recognized that the functionality provided for in the components and systems of computer system 402 may be combined into fewer components and systems, or further separated into additional components and systems.

### Computing System Components

The computer system 402 may comprise a capacity optimizer 414 that carries out the functions, methods, acts, and/or processes described herein. The computer system 402 may comprise capacity optimizer 414.

In general the word “system,” as used herein, refers to logic embodied in hardware or firmware or to a collection of software instructions, having entry and exit points. Systems are written in a program language, such as JAVA, C, or C++, or the like. Software systems may be compiled or linked into an executable program, installed in a dynamic link library, or may be written in an interpreted language such as BASIC, PERL, LAU, PHP, or Python and any such languages. Software systems may be called from other systems or from themselves, and/or may be invoked in response to detected events or interruptions. Systems implemented in hardware include connected logic units such as gates and flip-flops, and/or may comprise programmable units, such as programmable gate arrays or processors.

Generally, the systems described herein refer to logical systems that may be combined with other systems or divided into sub-systems despite their physical organization or storage. The systems are executed by one or more computing systems and may be stored on or within any suitable computer readable medium or implemented in-whole or in-part within special designed hardware or firmware. Not all calculations, analysis, and/or optimization require the use of computer systems, though any of the above-described methods, calculations, processes, or analyses may be facilitated through the use of computers. Further, in some embodiments, process blocks described herein may be altered, rearranged, combined, and/or omitted.

The computer system 402 includes one or more processing units (CPU) 406, which may comprise a microprocessor. The computer system 402 further includes a physical memory 410, such as random-access memory (RAM) for temporary storage of information, a read only memory (ROM) for permanent storage of information, and a mass storage device 404, such as a backing store, hard drive, rotating magnetic disks, solid state disks (SSD), flash memory, phase-change memory (PCM), 3D XPoint memory, diskette, or optical media storage device. Alternatively, the mass storage device may be implemented in an array of servers. Typically, the components of the computer system 402 are connected to the computer using a standards-based bus system. The bus system may be implemented using various protocols, such as Peripheral Component Interconnect (PCI), Micro Channel, SCSI, Industrial Standard Architecture (ISA) and Extended ISA (EISA) architectures.

The computer system 402 includes one or more input/output (I/O) devices and interfaces 412, such as a keyboard, mouse, touch pad, and printer. The I/O devices and interfaces 412 may comprise one or more display devices, such as a monitor, that allows the visual presentation of data to a user. More particularly, a display device provides for the presentation of GUIs as application software data, and multi-media presentations, for example. The I/O devices and interfaces 412 may also provide a communications interface to various external devices. The computer system 402 may comprise one or more multi-media devices 408, such as speakers, video cards, graphics accelerators, and microphones, for example.

### Computing System Device/Operating System

FIG. 4 is a block diagram depicting an embodiment of a computer hardware system configured to run software for implementing one or more embodiments of a capacity optimizer 414.

The computer system 402 may run on a variety of computing devices, such as a server, a Windows server, a Structure Query Language server, a Unix Server, a personal computer, a laptop computer, and so forth. In other embodiments, the computer system 402 may run on a cluster computer system, a mainframe computer system and/or other computing system suitable for controlling and/or communicating with large databases, performing high volume transaction processing, and generating reports from large databases. The computing system 402 is generally controlled and coordinated by operating system software, such as z/OS, Windows, Linux, UNIX, BSD, PHP, SunOS, Solaris, MacOS, ICloud services or other compatible operating systems, including proprietary operating systems. Operating systems control and schedule computer processes for execution, perform memory management, provide file system, networking, and I/O services, and provide a user interface, such as a graphical user interface (GUI), among other things.

### Network

The computer system 402 illustrated in FIG. 4 is coupled to a network 418, such as a LAN, WAN, or the Internet via a communication link 416 (wired, wireless, or a combination thereof). Network 418 communicates with various computing devices and/or other electronic devices. Network 418 is communicating with one or more computing systems 420 and one or more data sources 422. The computer system 402 may access or may be accessed by computing systems 420 and/or data sources 422 through a web-enabled user access point. Connections may be a direct physical connection, a virtual connection, and other connection type. The web-enabled user access point may comprise a browser system that uses text, graphics, audio, video, and other media to present data and to allow interaction with data via the network 418.

The output system may be implemented as a combination of an all-points addressable display such as a cathode ray tube (CRT), a liquid crystal display (LCD), a plasma display, or other types and/or combinations of displays. The output system may be implemented to communicate with input devices and/or interfaces 412 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output system may communicate with a set of input and output devices to receive signals from the user.

### Other Systems

The computing system 402 may comprise one or more internal and/or external data sources (for example, data sources 422). In some embodiments, one or more of the data repositories and the data sources described above may be implemented using a relational database, such as DB2, Sybase, Oracle, CodeBase, and Microsoft® SQL Server as well as other types of databases such as a flat-file database, an entity relationship database, and object-oriented database, and/or a record-based database.

The computer system 402 may also access one or more data sources 422. The data sources 422 may be stored in a database or data repository. The computer system 402 may access the one or more data sources 422 through a network 418 or may directly access the database or data repository through I/O devices and interfaces 412. The data repository storing the one or more data sources 422 may reside within the computer system 402.

### ADDITIONAL EMBODIMENTS

In addition to the above systems, methods, and devices for capacity optimization of cluster computer systems, other systems, methods, and device may be applicable to the embodiments herein. For example, the disclosures of U.S. Pat. No. 9,602,423, issued Mar. 21, 2017 entitled “SYSTEMS, METHODS, AND DEVICES FOR DYNAMIC RESOURCE MONITORING AND ALLOCATION IN A CLUSTER SYSTEM”, U.S. Pat. No. 8,706,798, issued Apr. 22, 2014 and entitled “SYSTEMS, METHODS, AND DEVICES FOR DYNAMIC RESOURCE MONITORING AND ALLOCATION IN A CLUSTER SYSTEM”, and U.S. patent application Ser. No. 15/204,783, filed Jul. 7, 2016 and entitled “SYSTEMS, METHODS, AND DEVICES FOR DETECTION OF HIGH MEMORY SWAPPING EVENTS IN DISTRIBUTED COMPUTING SYSTEMS” may be applicable to Kubernetes systems. The above listed applications and patent are hereby incorporated by reference in their entireties.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments may be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment may be used in all other implementations or embodiments set forth herein. Any methods disclosed herein need not be performed in the order recited. The methods disclosed herein may include certain actions taken by a practitioner; however, the methods may also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

What is claimed is:

1. A method for capacity optimization in a cluster system, the method comprising:
advertising, by a capacity optimizer via a Kubernetes application programming interface server, a node-level extended resource and a container-level extended resource;
assigning, by the capacity optimizer, a first value to the node-level extended resource and a second value to the container-level extended resource, wherein the first value is a value of a node-level built-in resource, and wherein the second value is a value of a container-level built-in resource;
periodically determining, via a metrics collector, a first usage amount of the node-level built-in resource and a second usage amount of the container-level built-in resource; and
updating, by the capacity optimizer, the first value of the node-level extended resource based on the first usage amount to maintain the first usage amount between a first lower threshold and a first upper threshold, wherein the capacity optimizer is configured to increase the first value of the node-level extended resource if the first usage amount is below the first lower threshold, and decrease the first value of the node-level extended resource if the first usage amount is above the first upper threshold, or
updating, by the capacity optimizer, the second value of the container-level built-in resource to maintain the second usage amount between a second lower threshold and a second upper threshold, wherein the capacity optimizer is configured to decrease the second value of the container-level extended resource if the second usage amount is below the second lower threshold, and increase the second value of the container-level extended resource if the second usage amount is above the second upper threshold.

2. The method of claim 1, wherein the node-level built-in resource is a central processing unit resource and/or a memory resource.

3. The method of claim 1, wherein the container-level built-in resource is a central processing unit resource and/or a memory resource.

4. The method of claim 1, further comprising displaying, on a graphical user interface, the first value, the second value, the first value of the node-level built-in resource, the second value of the container-level built-in resource, the first usage amount, and the second usage amount.

5. The method of claim 1, wherein the first lower threshold is 80 percent, and wherein the first upper threshold is 100 percent.

6. The method of claim 1, wherein the cluster system includes Kubernetes.

7. A method for capacity optimization in a Kubernetes cluster system, the method comprising:
advertising, by a capacity optimizer, via a Kubernetes application programming interface, a CPU node-level extended resource, a memory node-level extended resource, a CPU container-level extended resource, and a memory container-level extended resource;
assigning, by the capacity optimizer, a first value to the CPU node-level extended resource, wherein the first value is a value of a built-in node-level CPU;
assigning, by the capacity optimizer, a second value to the memory node-level extended resource, wherein the second value is a value of a built-in node-level memory;
assigning, by the capacity optimizer, a third value to the CPU container-level extended resource, wherein the third value is a value of a built-in container-level CPU;
assigning, by the capacity optimizer, a fourth value to the memory container-level extended resource, wherein the fourth value is a value of a built-in container-level memory;
updating, by the capacity optimizer, the value of the built-in container-level CPU and the value of the built-in container-level memory;
periodically determining, via a metrics collector, a first usage amount of the built-in node-level CPU, a second usage amount of the built-in node-level memory, a third usage amount of the built-in container-level CPU, and a fourth usage amount of the built-in container-level memory; and
automatically and dynamically updating, by the capacity optimizer, the first value, the second value, the third value, the fourth value, the value of the built-in container-level CPU, and/or the value of the built-in container-level memory to maintain the first usage amount, the second usage amount, the third usage amount, and the fourth usage amount between a lower threshold and an upper threshold.

8. The method of claim 7, wherein updating the value of the built-in container-level CPU comprises lowering the value of the built-in container-level CPU, and wherein updating the value of the built-in container-level memory comprises lowering the value of the built-in container-level memory.

9. The method of claim 7, wherein the capacity optimizer interacts with the Kubernetes cluster system via a Kubernetes application programming interface.

10. The method of claim 7, further comprising displaying, on a graphical user interface, the first value, the second value, the third value, the fourth value, the value of the built-in node-level CPU, the value of the built-in node-level memory, the value of the built-in container-level CPU, and the value of the built-in container-level memory.

11. The method of claim 7, wherein the metrics collector periodically determines the first usage amount of the built-in node-level CPU, the second usage amount of the built-in node-level memory, the third usage amount of the built-in container-level CPU, and the fourth usage amount of the built-in container-level memory every 20 seconds.

12. The method of claim 7, further comprising applying a text file, via a cluster administrator, to update the lower threshold and/or the upper threshold.

13. The method of claim 7, further comprising applying a text file, via a cluster administrator, to update a frequency of the periodic determination of the first usage amount of the built-in node-level CPU, the second usage amount of the built-in node-level memory, the third usage amount of the built-in container-level CPU, and the fourth usage amount of the built-in container-level memory.

14. A computing system for capacity optimization of a cluster system, the computing system comprising:
one or more processors and an electronic storage medium configured with specific computer-executable instructions that, when executed, cause the one or more processors to at least:
advertise a node-level extended resource and a container-level extended resource;
assign a first value to the node-level extended resource and a second value to the container-level extended resource, wherein the first value is a value of a node-level built-in resource, and the second value is a value of a container-level built-in resource;
periodically determine a first usage amount of the node-level built-in resource and a second usage amount of the container-level built-in resource; and
automatically and dynamically update the first value, the second value, or the value of the container-level built-in resource based on the first usage amount and the second usage amount to maintain the first usage amount and the second usage amount between a lower threshold and an upper threshold, wherein if the first usage amount is below the lower threshold, the first value is increased or the value of the container-level built-in resource is decreased, and if the first usage amount is above the upper threshold, the first value is decreased or the container-level built-in resource is increased, and wherein if the second usage amount is below the lower threshold, the second value is increased, and if the second usage amount is above the upper threshold, the second value is decreased.

15. The computing system of claim 14, further comprising a graphical user interface for displaying the first value, the second value, the value of the node-level built-in resource, the value of the container-level built-in resource, the first usage amount, and the second usage amount.

16. The computing system of claim 14, wherein the node-level built-in resource is CPU and/or memory.

17. The computing system of claim 14, wherein the container-level built-in resource is CPU and/or memory.

18. The computing system of claim 14, wherein periodically determining the first usage amount and the second usage amount occurs every 20 seconds.

19. The computing system of claim 14, wherein the lower threshold is 80 percent, and wherein the upper threshold is 100 percent.

20. The computing system of claim 14, wherein the cluster system comprises Kubernetes.
